(19) United States
(12) Patent Application Publication
(10) Pub. No.: US 2010/0274573 A1
(43) Pub. Date: Oct. 28, 2010

(54) DATA RELEVATION AND PATTERN OR EVENT RECOGNITION

(75) Inventors: Craig Frederick Feied, Washington, DC (US); Fidrick Iskandar, Fairfax, VA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 11/683,814

(22) Filed: Mar. 8, 2007

Related U.S. Application Data
(60) Provisional application No. 60/780,386, filed on Mar. 9, 2006.

(51) Int. Cl. G06Q 50/00

(52) U.S. Cl. 705/2

(57) ABSTRACT

An adaptable data management system that can address situations and/or scenarios ‘on-the-fly’ is provided. The innovation discloses a system that is not bound by intended content and therefore, allows associations (e.g., patterns, trends) and functionalities (e.g., notifications) to be expressed very rapidly (e.g., in real-time) to address health-related scenarios (e.g., bioterrorism). Accordingly, the system can autonomously decide what information to aggregate, how to receive the information, where to access the information, how to analyze the information, and what to do with the information.

### CROSS-REFERENCE TO RELATED APPLICATIONS

This application claims the benefit of U.S. Provisional Patent application Ser. No. 60/780,386 entitled “SYSTEM FOR DATA RELEVATION AND PATTERN OR EVENT RECOGNITION” and filed Mar. 9, 2006. The entirety of the above-noted application is incorporated by reference herein.

### BACKGROUND

Data management systems typically gather and store pre-defined data elements and information on specific predetermined topics and are designed to produce specific screens, reports, or alerts related to known questions and known areas of interest. The screens, reports, data structures, and tools that form part of such a system are designed for a specific purpose and that purpose is expressed throughout the design of the system. For example, data management systems designed for detection of anomalous events typically are programmed to gather a small number of specified data types using aggregated or summarized data that is acquired in a batch mode. Such a system may check periodically for the aggregated counts of certain pre-defined events and may then use those counts in specifically-designed processes in an effort to analyze trends and detect changes in the counts of those specific predefined events as compared to such counts during prior defined periods.

Conventionally, the entire system is designed and built with this purpose in mind and the specific data elements to be managed are specified with respect to a data collection, data storage, data analysis, and data presentation. When the analytical need changes, for example, in response to changing business conditions or changing health threats, then the traditional system must be redesigned and reprogrammed to meet the changing need. Re-designing and re-engineering a traditional system for new purposes typically is time-consuming and expensive, if it is possible at all. However, the modern era is one in which business needs change on a daily basis and new health threats can emerge and mutate with astonishing rapidity.

It is infeasible to redesign and reprogram a conventional data management system or a batch data collection system for each new situation when new situations may arise daily or even hourly. Furthermore, the cost of delays in detection is such that existing systems and particularly batch mode systems already fail to meet the existing need.

In health surveillance, for example, it has been estimated that the cost of delays in recognizing and responding to an outbreak of smallpox will exceed $1 billion per hour of delay, and that many people will die unnecessarily due to delays in the initial recognition of the problem. To mitigate threats of this kind, effective surveillance must be carried out in real-time or near-real-time. Furthermore, each new emerging threat, such as SARS or Avian Influenza, flesh-eating bacteria or drug-resistant strains of clostridium dificile, sarin gas or anthrax, presents a new challenge that must be met as rapidly as possible.

### SUMMARY

The following presents a simplified summary of the innovation in order to provide a basic understanding of some aspects of the innovation. This summary is not an extensive overview of the innovation. It is not intended to identify key/critical elements of the innovation or to delineate the scope of the innovation. Its sole purpose is to present some concepts of the innovation in a simplified form as a prelude to the more detailed description that is presented later.

The innovation disclosed and claimed herein, in one aspect thereof, comprises an adaptable data management system that can address situations and/or scenarios on-the-fly eliminating a need for preprogramming (or reprogramming) as was necessary in conventional systems. As described above, new threats such as bioterrorism increase the usefulness of a system that can adapt on-the-fly in order to meet or address health-care concerns. This class of problem can only be addressed by a comprehensive real-time system that is fully configurable on-the-fly to meet most any emerging need, regardless of whether that need was predefined or previously recognized. Accordingly, the subject system provides mechanisms that need not be restrictively defined in terms of what kind of data it is intended to receive, when and how it is intended to receive them, from what sources and in what formats the data will come, what analytical methods will be used to analyze the data, to what the data will be compared, and how the data will be presented. In other words, the subject innovation discloses a system that is not bound to by intended content and allows new organization and new functionality to be expressed very rapidly. The system is fully configurable on-the-fly to meet emerging needs so long as any relevant data exists within or can be discovered by the system.

In another aspect, the innovation relates to general data management systems and more particularly to computerized systems and methods for receiving organizing, compiling and analyzing many different types of data originating from many different sources (regardless of format) and using that data to monitor events and to detect and explore anomalies and patterns in data through a variety of manual and automated methods. The system permits and facilitates manual exploration of the data separately and in conjunction with automated methods for data analysis and detection of patterns of interest. The system can replace existing slow and error-prone manual methods for data collection, aggregation, investigation, and analysis and can also make possible types of data investigations and analyses that previously were impossible either because they were too time-consuming and expensive or because they were of such large and varied scope as to be practically impossible regardless of time and expense.

In another aspect, the system can automatically alert designated persons (e.g., health care professionals) or other systems to the presence of arbitrary events, trends, or patterns as they are detected or as the probability of their being detected rises above some predetermined or inferred threshold. Further, the innovation provides mechanisms that operate with a broad class of events of any kind, in any domain, that may be associated with data or may cause data to be produced, including all forms of evolving medical and public health threats such as bioterrorism, emerging diseases accidental toxic spills, and outbreaks of endemic, epidemic, or pandemic illness.

Among other applications, the system may be used as a real-time surveillance and situational awareness system to alert hospitals, medical professionals, public health authorities, and other responsible parties as soon as a data pattern or anomaly is detected that may have resulted from an act of biological or chemical terrorism or may be related to emerging diseases or new health threats of any type. This ability to detect and alert functions without limitation to diseases or biological events, without limitation as to the population of persons or things involved, and without limitation to any geospatial region or temporal period.

Furthermore, the system can detect the anomalous absence of an event or pattern of events as easily as the presence of an event or pattern of events. The system may detect nosocomial infection or hospital room contamination as easily as it detects case clusters or community outbreaks of disease. In ordinary daily use, the system can be used to provide rapid access to most any and all relevant data within an appropriate context. Accordingly, the innovation can facilitate searching, sorting, filtering, aggregating, arranging, displaying, and transmitting data. Potential usefulness may include, but is not limited to, applications in manufacturing, finance, research, public utilities, service industries transportation, communications, publication, library science, healthcare medicine, and public health.

In yet another aspect thereof, an artificial intelligence component is provided that employs a probabilistic and/or statistical-based analysis to prognose or infer an action that a user desires to be automatically performed.

To the accomplishment of the foregoing and related ends, certain illustrative aspects of the innovation are described herein in connection with the following description and the annexed drawings. These aspects are indicative, however, of but a few of the various ways in which the principles of the innovation can be employed and the subject innovation is intended to include all such aspects and their equivalents. Other advantages and novel features of the innovation will become apparent from the following detailed description of the innovation when considered in conjunction with the drawings.

### BRIEF DESCRIPTION OF THE DRAWINGS

FIG. 1 illustrates a block diagram of a system that facilitates data management in accordance with an aspect of the innovation.

FIG. 2 illustrates an exemplary flow chart of procedures that facilitate receiving, transforming, and presenting data in accordance with an aspect of the innovation.

FIG. 3 illustrates a detailed block diagram of an example data collection layer in accordance with an embodiment of the innovation.

FIG. 4 illustrates a detailed block diagram of an example data transformation layer in accordance with an aspect of the innovation.

FIG. 5 illustrates a detailed block diagram of an example data delivery layer in accordance with an aspect of the innovation.

FIG. 6 illustrates a detailed block diagram of an example data presentation layer in accordance with an aspect of the innovation.

FIG. 7 illustrates a detailed block diagram of a system that facilitates data acquisition, storage and presentation in accordance with an aspect of the innovation.

FIG. 8 illustrates a block diagram of a computer operable to execute the disclosed architecture.

FIG. 9 illustrates a schematic block diagram of an exemplary computing environment in accordance with the subject innovation.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding of the subject innovation. It may be evident, however, that the innovation can be practiced without these specific details. In other instances, well-known structures and devices are shown in block diagram form in order to facilitate describing the innovation.

As used in this application, the terms “component,” “module” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

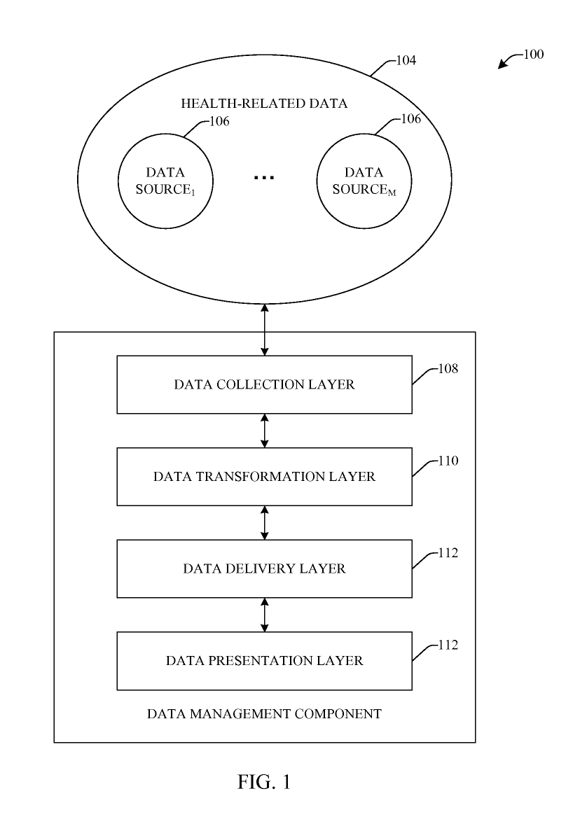

Referring initially to the drawings, FIG. 1 illustrates a system 100 that facilitates data management in accordance with an aspect of the innovation. More particularly, the system in FIG. 1 enables data to be collected, analyzed and presented ‘on-the-fly’ in accordance with pattern and/or trend determination. Generally, the system 100 can include a data management component 102 that facilitates extraction of data from a health-related data network 104. The health-related data network 104 can include 1 to M data sources 106, where M is an integer. In operation, the data sources 106 can include data of most any format or type. As well, the health-related data network 104 can be a distributed network of sources 106.

As shown, data management component 102 includes a data collection layer 108, a data transformation layer 110, a data delivery layer 112 and a data presentation layer 114. Each of these layers is capable of processing data autonomously. In other words, each layer need not rely upon the others in order to perform data management operations. The functionality of each of these layers will be better understood upon a review of the drawings and corresponding description that follows.

The subject system 100, and more specifically the data management component 102 (and subcomponents 108, 110, 112, 114) facilitates automatic event and pattern recognition and reporting as a byproduct of ordinary activities, with extensive built-in functionality including a built-in ability for data exploration from the aggregate to the detail level. The system 100 can provide rapid and intuitive access to massive amounts of relevant data of all types (e.g., health-related data network 104 and sources 106). Moreover, the system 100 can facilitate the detection and exploration of patterns and anomalies in data of most any types, received and aggregated from any sources 106, without limitation to the types of events or patterns and anomalies, without limitation as to the populations or cohorts of persons or things involved, and without limitation to any geospatial region or temporal period.

The system 100 can also serve as a fast and easy-to-use method for displaying disparate types of data together, for invoking other embedded or external methods to assist with processing or viewing data, and for creating exploring, and managing cohorts of data records dynamically defined in most any manner. The system 100 and corresponding methods used to create and operate the system 100 are not obvious and differ significantly in design and function from conventional systems. The subject system 100 can continuously receive data from all available or relevant sources 106 in real-time or near-real-time and apply real-time automated analysis to the received data together with any data maintained within system 100. Moreover, the system 100 also facilitates manual recognition of patterns and anomalies and forensic investigation of patterns once recognized.

It is possible to detect and investigate most any anomalous event that is reflected in the normal patterns of data arising from most any source 106. It is to be understood that the larger the number of data sources 106 and the shorter the time lag between data creation and data transmission, the greater the value of the system 100 for detection of abnormal situations and for assisting with response. In accordance with the foregoing components and advantages, data can be received in real-time or near-real-time, processed, aggregated, tagged, translated and stored, used to trigger automatic analyses and automatic responses and then made available for manual inspection and exploration using a variety of specialized tools and methods. This process results in a real-time system 100 that can reveal patterns, trends, anomalies, and expose the underlying forces that create triggering processes and functions accordingly.

Effectively, the system 100 can apply its full capabilities (e.g., collection, transformation, delivery and presentation) on whatever data exists or can be captured or made to exist. The existence of relevant data thus becomes an important factor defining functionality of the system 100 for most any particular purpose.

It is to be understood and appreciated that the data management component 102 and subcomponents (108, 110, 112 and 114) can be written using conventional programming languages and tools in a conventional manner. One factor of uniqueness of the system 100 and its value lie not only in the specifics of the code or in the specific functions executed by any component (e.g., 102, 108, 110, 112, 114), but also in the overall manner in which the system 100 is organized and assembled. Another factor of the uniqueness of the system 100 lies in the avoidance of generally-accepted techniques and practices that exert heretofore unrecognized negative effects on the performance, cost complexity, and maintainability of traditional systems. In conjunction with the special techniques that are included within this system 100, significant value lies in the systematic exclusion of commonplace and usual data management and programming practices that are ordinary seeming and difficult to avoid. In this respect, important aspects of the subject innovation include the organization of the flow of data and information, the definition and creation of the appropriate layers (e.g., 108, 110, 112, 114) of indirection, the absolute avoidance of cross-dependencies between modules and components of the system 100 or between the system 100 and its data or the system 100 and any external process or function, and the selection of the proper place in which to bind each action or function.

The system 100 includes a comprehensive alerting functionality that permits triggering of most any function on the basis of a detectable event, including the arrival of most any sort of message, including time clock ticks, or upon a change of a data element or transformation of most any combination of data elements within the system 100. Additionally, a comprehensive scheduling functionality that can be caused to trigger most any action of most any kind on an arbitrary schedule is provided.

The system 100 further facilitates an ability to dynamically monitor a directory or other location on a local or remote computer and to automatically import files that appear in such directory or location, causing files to be split into messages if appropriate. Further, the files or messages can be passed to a message queue, a series of data transformation engines and on to a central (or distributed) data store.

As will be better understood upon a review of the figures that follow, many components and modules may be located at a multiplicity of sites, being able to communicate with each other and amongst themselves by ordinary means such as radio, telephone, optical transmissions, private network traffic, public network traffic, or other methods for transmitting information from one place to another. Some components or modules may be placed at a source site where data is first developed, for the purpose of extracting data from a source system and transmitting it to the destination system in real-time or near-real-time. Others can be located at a local, regional, or central data aggregation sites.

With respect to pattern discernment, the system 100 permits the discernment of patterns that previously were difficult to discern because they were lost in a great volume of data that could not otherwise easily be reviewed, or because they were embodied in data that was split between or among disparate systems no one of which alone contained sufficient data to reveal the pattern. Further, patterns were difficult to discern because it was difficult to apply the appropriate tools for revealing the pattern.

Following is a list of examples of patterns that are easily discerned by using the subject system 100. It is to be understood that these examples are provided to add perspective to the innovation and are not intended to limit the innovation in any manner As well, it will be noticed that some of these examples do not relate directly to health-care data. As such, it is to be appreciated that the features, functions and benefits of the subject system 100 can be applied to other industries without departing from the spirit and/or scope of the innovation described herein.

An association between a particular automobile tire and a particular model of automobile together with an increased incidence of vehicular crashes. An association between temperature and the incidence of O-ring failure. An association between administration of a particular medication and some physiologic event such as a change in vital signs, the manifestation of an illness, or the incidence of death. Temporal, geospatial, and multi-dimensional patterns in the occurrence of any event for which data elements are available, such as the occurrence of endemic, epidemic, or emerging disease; as well as patterns in the relationship between such occurrences and any other data elements that may exist or be made to exist within the System. The association between weather or climate and the rate and location of occurrence of events related to human or animal health and well-being such as gastrointestinal illness following rainfall, or loci of heat-related illness during hot (or cold) weather.

Additional examples include, but are not limited to: Recognition of trivial associations, such as an association between the incidence of a disease and the incidence of prescribing of medications used to treat that disease, and also the recognition of detailed patterns and relationships related to such trivial associations, such as the time lag between the onset of symptoms and the first administration of a medication, or the recognition of subgroups of patients in whom certain medications fail to be administered, or of subgroups of patients for whom medications are prescribed but not purchased, or are prescribed and purchased but not refilled in a timely manner. Recognition of temporal and geospatial patterns of disease, including outbreaks, based on all the aggregated data available within the system 100 including automatically acquired vital signs, laboratory results, primary patient complaints however acquired, purchase or use of medications and products, whether prescribed or available over the counter, diagnoses radiographic images and the interpretations thereof, work and school absenteeism, traffic and travel patterns, telephone call data, noise volumes, air sampling data, waste treatment data, internet activity data. While many examples are listed above, it is to be understood that other examples exist that are to be included within the scope of this disclosure and claims appended hereto.

As will be understood upon a review of the description that follows, the subject system 100 has many advantages. It provides an improved mechanism to add functionality to existing systems and processes that produce data but do not have sufficient built-in analytic or monitoring capabilities. This provides a method by which to add functionality without requiring a migration to entirely new data systems (e.g., avoiding the need to ‘rip and replace’). It provides a method whereby data may be aggregated even when it originates with business competitors, with legacy systems, with closed or proprietary systems, with systems using different human or computer languages or vocabularies, with systems based on different protocols and using different encodings and data structures, or with others not wishing or not able to engage in efforts to make their systems interoperate with similar or disparate computer systems from other vendors.

The subject system 100 offers the ability to create and manipulate copies of the original data and of all derivative data without ever affecting the source data system and to maintain multiple copies of the data such that one copy continues to match exactly what was sent by the source system, even to the inclusion of known flaws and discrepancies in that data, while other copies of the data may be freely improved and corrected for subsequent use where appropriate, and displayed in new ways without the need to modify the original source application or to reverse-engineer and replicate the working functions of the original source application. Furthermore, it is possible to deliver automatic feeds of corrected data back into the source system for merging and subsequent retransmission as corrected. Moreover, the subject system 100 provides a way to link multiple data sets across applications even though the original source applications were not originally designed or intended to link with these multiple data sets.

The innovation can address issues of privacy protection with regard to maintaining privacy of sensitive information. Accordingly, the system has the ability to control the release of each data element and of all data elements in groupings that may be desired based upon combination of attributes describing the logged-in user, the location from which the query is being made, the mechanism by which the user has been authenticated, the time of day, the degree of consistency with prior queries, and many other attributes. Data may be made available in aggregate form only, or in granular form, and data about specific individuals may be de-identified or fully identified as appropriate to the specific use being made and the rights of the user.

With regard to sampling frequency, in the real-world, it is impossible to know a priori what will be the patterns of interest over time, thus a significant advantage is obtained if data samples are acquired at the highest existing level of granularity and with the shortest possible latency. It is well-known that, in measuring analog electrical signals by digital sampling, data samples must be acquired at least twice as frequently as the highest frequency signal that is to be measured. A similar principle applies in the practice of pattern detection in the flow of events by the use of data streams, where the data elements represent samples of the actual continuous course of events.

Today, it is impossible to accurately detect, recognize, and measure events that occur with a single-cycle frequency smaller than half the sampling interval. For example, a pattern in which the likelihood of payment denial of medical insurance claims is higher for claims processed in the last hour of each day and cannot be detected by analyzing data that is aggregated by day. Similarly, a pattern of excess deaths for patients who are admitted to an intensive care unit after 5 PM on weekends cannot be detected with daily aggregates of data. The fact that on Wednesdays twice as many patients get tired of waiting and leave an emergency department without being seen as on any other day of the week can be detected using daily aggregates of data, but the fact that the problem occurs entirely between 11:00 am and 2:00 pm when physicians have a weekly staff meeting would be missed entirely.

The subject innovation offers the advantage that most any pattern detectable from the existing data may be detected with the system 100 in its usual operating condition

With regard to tolerance for missing data, under certain circumstances the system 100 may serve as a super-aggregator in that it may receive data from other systems that themselves aggregate data using existing legacy methods and approaches, such as systems that periodically check with point-of-sale machines for periodic counts of specific indicators, or systems that merely indicate when a pre-set threshold has been exceeded for a pre-determined variable of interest. In such a case the subject innovation may have a diminished capacity to detect patterns and anomalies to the extent that the secondarily aggregated data is incomplete, insufficiently granular, fails to include data elements that were not a priori known to be of interest, or fails to be sufficiently timely.

However, an advantage of the system 100 is that the existence of a very large number of granular data elements from a large number of sources allows poor resolution from a small number of data sources to be tolerated without significant loss of overall sensitivity or specificity in pattern detection. This relative tolerance for missing data elements is an important advantage of the system 100.

Additionally, the system 100 effects simplified planning. One important purpose and value of the system 100 is to render ordinary system specifications and planning processes relatively unnecessary by enforcing late binding of all functionality at the user level. A typical system design or implementation process begins with the development of functional specifications, the selection and definition of fields that will be defined within the system, the design of screens, reports, and alerts and the definition of inputs and outputs. After this process is complete, programmers work to build a computer program that meets the functional specifications. In contrast, the subject system 100 makes it unnecessary to develop functional specifications. Using this system 100, it is unnecessary to select or define the data fields that will be defined within the system 100, to design screens, reports, or alerts, or to define inputs and outputs.

Rather, any class of data-related problem may be addressed in essentially the same manner; all available existing data is extracted from all available source systems, data is tagged with as much metadata as possible, data is stored in most any convenient optimized fashion and data is displayed within a cohort-oriented context that automatically produces screens and reports of interest. User-specific special screens, reports, and alerts may be defined by each user or group of users at any time, with no need for reprogramming Many other native functions of the system 100 are of significant value, the more so by being fully integrated into the system 100 as a whole.

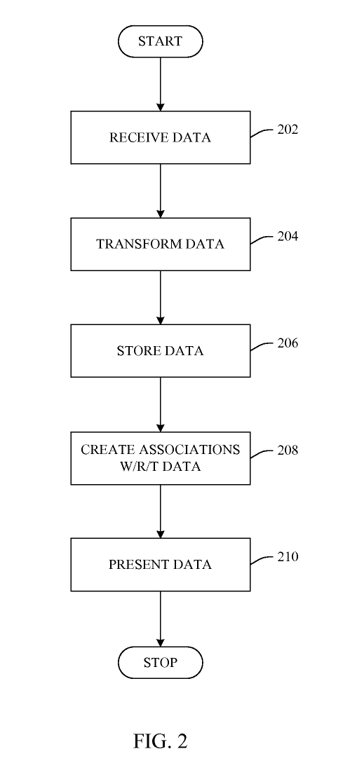

FIG. 2 illustrates a methodology of managing health-related data in accordance with an aspect of the innovation. While, for purposes of simplicity of explanation, the one or more methodologies shown herein, e.g., in the form of a flow chart, are shown and described as a series of acts, it is to be understood and appreciated that the subject innovation is not limited by the order of acts, as some acts may, in accordance with the innovation, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 202 data can be received from most any number of sources, for example, from sensory mechanisms, distributed databases, application inputs, manual inputs, enterprise, etc. In one aspect, granular data can be automatically acquired from all known or all available sources in a field, without respect to type or complexity of data. Data can be acquired in real-time or near-real-time by a variety of methods. For example, data that is received, e.g., pushed (or pulled) from a source system in real-time or on a scheduled basis, may include most any data element that is capable of being sensed, detected, entered, captured, represented electronically or photonically and then transmitted from one system to another.

At 204, the collected data is transformed. In other words, a translation and metadata encoding process can be automatically applied to the data. In one aspect, this translation and metadata encoding process can be applied using the unified medical language system (UMLS) metathesaurus and all vocabularies that are mapped and encoded within the metathesaurus, and any other vocabulary that may be defined and found useful for translation and for the creation of metadata related to any data element within the system.

The data can be stored at 206 in most any convenient data structures, yet the data can be caused to appear as if it were in a single integrated dataset. At 208, associations between and among the data elements and records received from multiple disparate sources can be automatically created. In operation, the associations can be based at least in part upon on any combinations of data or metadata that may exist within or be discoverable by the system. Finally, at 210, most any combinations of data elements can be made possible to view and explore most any combination of data elements.

In addition to simple viewing of the data, it is to be understood that the presented data can be employed to trigger processes and/or functions as desired. By way of example, the data can be make it possible to automatically apply any analytic tool to any grouping of data elements. Further, the data can make it possible to automatically apply to most any grouping of data elements, most any display or presentation tool, such as tools used for mapping graphing, rendering images or sounds, or producing physical sensations (e.g., haptic feedback).

Examples of typical analytic functions can include, but are not limited to, automatically creating time-series graphs of the occurrence of any event, automatically comparing to any prior period, as arbitrarily defined in a post-hoc manner, and to all prior periods that exist in the database, automatically predicting when a threshold may soon be reached or exceeded based on the slope or rate of change (e.g., first derivative analysis), automatically creating notifications of most any kind (e.g., audible, visible, vibratory, textual) when arbitrary thresholds are reached or exceeded or are predicted to be reached or exceeded, or automatically trigger most any action that may be accomplished by a job server. It is to be appreciated that the aforementioned examples are included to add perspective to the innovation and are not intended to limit the innovation in any way. As such, it will be understood that other scenarios exist that are to be included within the scope of this disclosure and claims appended hereto. Still further, it will be understood that it is possible to schedule any of the aforementioned actions on a recurring basis.

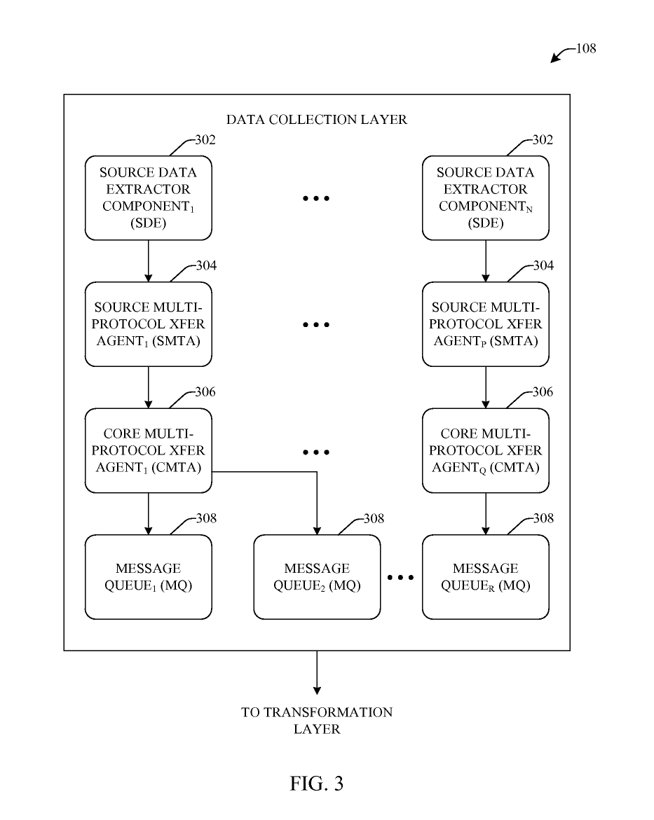

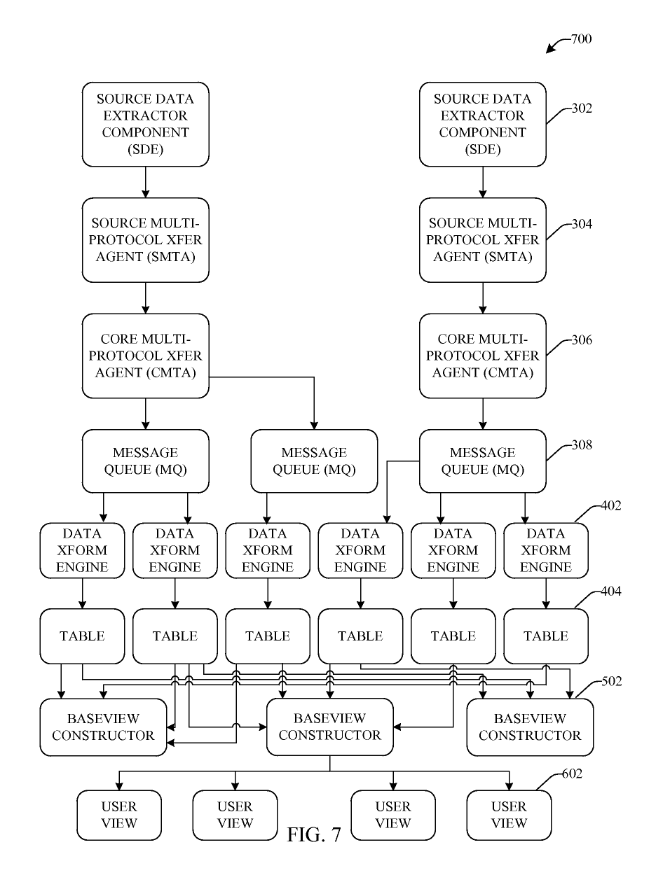

Referring now to FIG. 3, there is illustrated a block diagram of an example data collection layer component 108. Generally, the data collection layer component 108 can include 1 to N source data extractor components (SDEs) 302, 1 to P source multi-protocol transfer agents (SMTAs) 304, 1 to Q core multi-protocol transfer agents (CMTAs) 306 and 1 to R message queues (MQ), where N, P, Q and R are integers. Each of these components will be described in more detail below as well as in combination with other subcomponents of the system 100 in FIG. 7 that follows.

Referring first to the SDEs 302, these components are employed within the collection layer 108 to extract data from most any number of data sources (e.g., 106 of FIG. 1). In operation, an SDE can be employed to monitor a source in real-time (or as otherwise desired) thereby automatically extracting data as appropriate or desired. It is to be understood that triggers for extraction can be inferred or preprogrammed (e.g., via policy) in accordance with aspects.

The SMTAs 304 are employed to transmit messages to receivers. In operation, the SMTAs 304 can maintain data elements (e.g., cache, buffer) thereafter making the data available on an as-needed or as-desired basis which, can be pre-programmed or inferred. The CMTAs 306 are similar to SMTAs 304 where they are primarily employed to receive data messaged from an SMTA 304 (or other sender), to authenticate the messages, to tag the messages and place the messages into an appropriate message queue (MQ) 308.

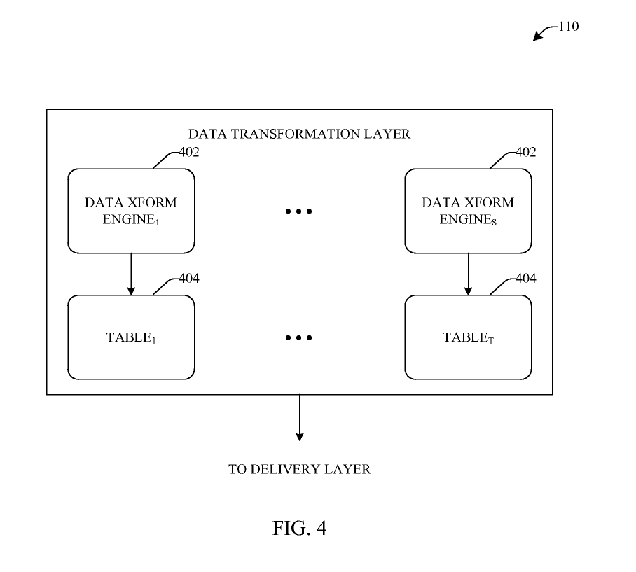

FIG. 4 illustrates a block diagram of an example data transformation layer component 110 in accordance with an aspect of the innovation. Generally, data transformation layer 110 can include 1 to S data transformation engines (DTEs) and 1 to T tables, where S and T are integers. Each of these components will be described in greater detail below and in more detail with regard to FIG. 7 that follows.

The DTEs 402 can communicate with one or more MQs (308 of FIG. 3) as desired. One the data is read, it can be transformed and written into a table 404. Further, it is to be understood that each DTE 402 can also read data from any table 404 for which authorization is granted. Data can be maintained within the tables 404 in most any manner known in the art. Additionally, data can be stored in most any manner regardless of structure of the data elements.

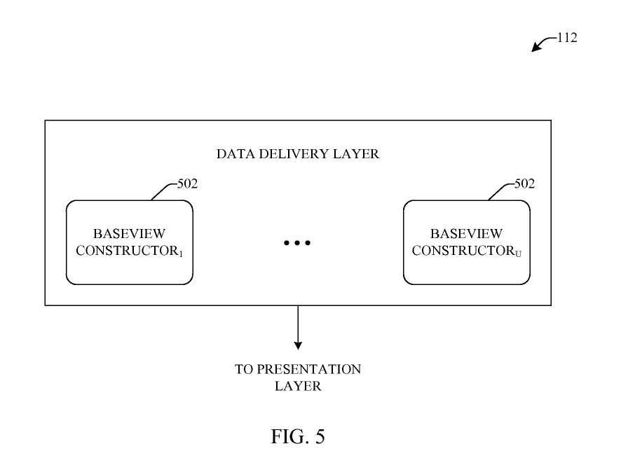

Referring now to FIG. 5, an example block diagram of a data delivery layer 112 is shown. As illustrated, the data delivery layer can include 1 to U baseview constructors 502, where U is an integer. The baseview constructors serve as a layer of indirection between the tables (404 of FIG. 4) and any user or process that seeks access to the information stored within the tables (404 of FIG. 4).

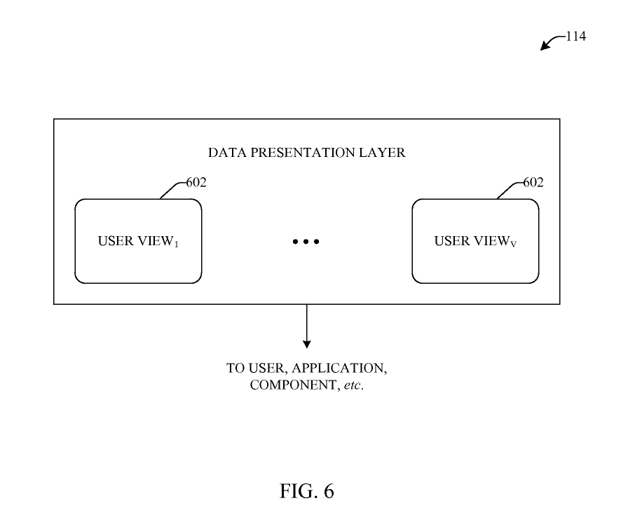

Turning to FIG. 6, an example block diagram of a data presentation layer 114 is illustrated having 1 to V user views 602, where V is an integer. Each user view can include a subset of data elements chosen from a single baseview constructor (502 of FIG. 5), together with attributes associated with a particular view. Each of the aforementioned layers and subcomponents will be better understood upon a review of FIG. 7 that follows.

Turning now to FIG. 7, illustrated is a flow diagram showing an example generic flow 700 of data from a multiplicity of data sources into the system and through a series of core components/modules as well as a generic method for viewing the aggregated data through cohorts and applying arbitrary methods to the data. Referring to FIG. 7 in a top down manner, data can be extracted from a data source by an SDE 302 and then communicated to a SMTA 304, which transfers the data to a CMTA 306. The CMTA 306 can place the data into one or more MQs 306. Data within an MQ 306 is read by one or more DTEs 402 which apply rules to manipulate and transform the data, creating metadata as needed and writing the data and metadata into one or more tables 404.

Data residing in tables 404 can be made available through one or more baseview constructors 502 that expose selected data elements from selected tables 404 and apply defined filters to create data resources containing all data elements of interest across a cohort of entities of interest for an arbitrary time period of interest (e.g., baseviews 502). Data defined in baseviews 502 is made available through one or more user views 602 that consist of specifically chosen data elements from the baseview 502, presented in a defined (or inferred) order and a defined (or inferred) format with defined (or inferred) criteria for inclusion or exclusion defined (or inferred) sort orders, and other defined (or inferred) display attributes.

Any data element or combination of data elements within the user view 602 may be used to trigger or activate one or more components (not shown) that are capable of executing any instruction or series of instructions, that have full access to all resources and data elements of the system, and that have in addition the ability to serve as new data sources each with its own data extractor (SDE 302) and access to the full chain of data flow paths as described above.

Connections between one component of the system and another component of the system, as for example between the SDE 302 and the source or between the SDE 302 and the SMTA 304, may be by means of internal system buss connections, serial or parallel connections, wired wireless, or optical transmission whether over a network or point-to-point telephonic connections, point-to-point connections using most any medium, optical sensors, sensors of motion or of location or of forces or of chemical entities or of sounds, chemical or biochemical signaling neural or cellular connection, or signaling based upon location or activity or most any other attribute of one component being detectable by the other, or any other means permitting the detection and recording of information resulting in communication or data transfer between the two modules. In some aspects, two or more components can reside within the same machine and in other aspects, two or more components may be integrated together into a single system or computer program, in which case connections between one and another are implicit.

By way of example, in some aspects the SMTA 304 may be running in the same machine as the SDE 302, in some cases the SMTA 304 itself may serve as the SDE 302, and in some cases the SDE 302 may be part of or integrated into the source system itself, in any which event connections between the two components are implicit. In another embodiment, each component is separate from each other component, and the connection between any two is made by whatever means is most conveniently available within whatever hardware and software may be used, including most any operating system that may be present.

In the embodiment this might be a network connection using most any convenient network architecture such as TCP/IP, allowing connections between and among components located most anywhere on most any interconnected network. In the diagram of FIG. 7, the components illustrated are as follows, having the properties described infra.

A data source (not shown) may be any existing system or group of systems from which data may be emitted or extracted. Data sources may be electronic or non-electronic, and if non-electronic may function though chemical mechanical, photonic, or any other means. A data source may also be an organization, a building, a location, a city, or a person or a creature or group of persons or creatures of any size or type.

A data extractor (SDE 302) is used to extract data from each of any number of arbitrary data sources. An SDE 302 may exist within the source system itself, as when a stored procedure runs within an existing database and is programmed to emit data records to an SMTA 304 whenever a change occurs in the source data tables. Conversely, an SDE 302 may exist semi-independently or completely independently of the source system, as when an SDE 302 independently monitors hard disk activity and executes a read after every detected write, compiling all changes into a data record and delivering that record to a SMTA 304.

Other examples of SDEs 302 could be a process that emulates a user in the source system and reads screen data, a process that obtains a copy of printer data streams, a process that detects the arrival of new files in one or more locations and opens them for processing, a process that decodes information from a camera pointed at a source system, a process that reads from sensors using any protocol, or any other method or process that can obtain data from a source system. The SDE component 302 may or may not be the designated recipient of source data.

The component 302 has the native ability to ‘eavesdrop’ or monitor, allowing the original data to pass unimpeded to its original destination while simultaneously making a copy of the data and delivering it to another destination. This eavesdropping capability may depend upon a combination of hardware and software for its efficacy, and may or may not require restructuring of the external data flows. For example, a copy of data being transmitted to a printer by a parallel protocol may be read directly from the output buffer of the sending machine, or the parallel connection may be made to pass into an external SDE 302 and back out on another port, a copy of the data being retained in the SDE 302 for subsequent handoff to a transfer agent (e.g., ‘man in middle’).

An SDE 302 may extract data from biological systems by detecting biological and non-biological parameters whether by biochemical electrical, electromagnetic, optical, acoustic, or other means. Data extraction may be time-based or location-based or based on size or shape or mass or acceleration or most any other function or attribute or behavior of a source system. In every case the data extraction function can be optimized primarily in terms of interactions with the source system, and the primary function of an SDE 302 is to deliver data in some arbitrary and convenient message format to the SMTA 304.

One primary purpose of the SMTA 304 is to transmit messages to a plurality of receivers, and especially to another MTA (e.g., 306) serving as a primary core receiver as shown. The SMTA 304 is an instantiation of the general MTA component, which is also used in the CMTA 306. The MTA component has the ability to receive data by a variety of methods and place that data into a buffer, then to read data from the buffer and transmit it by a variety of methods. A log can be maintained of each data reception or data transmission transaction. The component may be used alone or in groups. A single instantiation of the component may be configured to receive or send over one or more ‘channels,’ each channel including a single method of receiving or sending data.

Multiple instances of the component may exist within the same machine, being configured to work in tandem to produce the desired data management effect. The receiving and the transmitting portions of the component are designed such that they may receive and send data by most any means, using most any protocol. Typical channels include such examples as parallel or serial line protocols, USB or Firewire protocols, File Transfer Protocol (FTP) and secure FTP, HyperText transfer protocol (HTTP) and secure HTTP named pipes, directory monitoring with file reading or writing, direct database connectivity using most any protocol, and most any network or socket communication using arbitrarily defined signaling protocols. The MTA can maintain a buffer between inbound and outbound instances of the engine. In one aspect, the size of the buffer can be limited only by the physical storage space available, and may be expanded simply by increasing the size of the attached or embedded storage device using commercially available storage technologies.

The CMTA 306 is similar to the SMTA 304, with additional features to facilitate its primary purpose, which is to receive data messages from a SMTA 304 or from any surrogate sender, to authenticate those messages based on authentication and authorizations of the sender, to tag messages with appropriate headers and metadata, and to place the messages into one or more MQs 308. Data may be directly received from a surrogate sender, for example as when a source system is natively capable of sending real-time data transactions using some robust connection-oriented protocol with rollback and auto-recovery features, or when it is preferable for most any reason to tolerate a lower level of reliability and robustness.

Each MQ 308 includes native messages of one or more types, and each message is associated with attribute indicators containing metadata about the message queuing process. Attributes may indicate whether the message has been parsed, and by which DTEs 402, and from what source it was received, and when, and how, and what authentication method was used. Message queues may exist in the same machine as other components or they may be sequestered into dedicated message queue computers.

A single machine may contain one or more instances of an MQ 308. A single message may appear in one or more queues depending on the configuration of the system. Messages within the queue are associated with a date and time and unique ID sufficient to distinguish each message from each other message and to determine the order in which messages should be processed. Messages within the queue are available to be read and acted upon by one or more DTEs 402. After some period of time, or after some series of events have occurred, messages may be moved from the active queue into one or more message archives, from which location they continue to be available to other components of the system.

All messages whether in the active queue or in a message archive or in any other location, may be reprocessed at any time. Any table in the system may perform the functions of an MQ 308 for outbound or transitional streams. The MQ 308 here described is special in that it contains preprocessed data messages which must match exactly whatever was transmitted from a source system.

DTEs 402 may exist in the same machine as other components, or they may be sequestered into dedicated DTE 402 computers. A single machine may include one or more instances of a DTE 402. A single DTE 402 may read from one or more MQs 308 depending on the configuration of the system. An important attribute of the system is that each DTE 402 can be deliberately restricted in where it may read and where it may write DTEs 402 may subscribe to and read from any number of MQs 308 and may also read from any other component to assess the overall state of the system, including the status of data sources and SDEs 302.

DTEs 402 may also read from any exposed table 404, that is, from any table 404 to which they have been granted read privileges and from certain abstracted data structures, for example, from SQL views based upon tables 404 that are not themselves exposed. Each DTE 402 may write to only one table 404, and each table 404 may be written to by only one DTE 402. Within a DTE 402, scripts and mapping processes may create data elements (along with attributes and metadata for each data element) that are destined to reside in the destination table 404 for that DTE 402. When a script is finished processing a particular message, each data element, attribute, and item of metadata must be fully resolved and will be written exactly once. In other words, the current contents of each particular row and column entry within a table 404 is unambiguously known to have been created by the action of a single composite script upon a single message in a single operation.

The combination of script, message, any other system data that was read by the script, and the final output as written may be instantly examined at any time by an authorized user of the system. The benefits of this particular method are highly significant in producing overall benefit in the later management and operation of the system.

Data is stored within a multiplicity of tables 404 that may be part of a multiplicity of databases. Data may be organized within and among tables 404 in any convenient manner. The structure of the tables 404 is unrelated to the structure of the data, unrelated to the structure of the original data source, and unrelated to the structure of use or presentation that may be made of the data within or without the system. A table 404 may include all the data from a single original source of data or all the data needed for a particular function to be performed by the system, or data mixed together from many sources randomly or aggregated according to any convenient purpose.

Tables 404 do not participate in a hierarchical structure or taxonomy, nor do they utilize any defined relations as is usually done with relational databases, nor are they required to be object databases. All knowledge about data structures and relationships (such as usually would be localized in a chart of accounts, a structured table hierarchy, a set of public methods, or a set of table relations) can be encoded in a series of attributes and metadata elements that are associated with each data element.

The storage of data elements, attributes, and metadata may be in column-oriented tables 404 in which each column contains a defined data element, or in hybrid tables 404 in which some columns contain table column-defined data elements and others contain generic data plus descriptors (including such complex data structures as spreadsheets or XML or SGML), or in hybrid tables in which some columns contain arbitrary data elements whose meaning must be derived from the contents of a different column, or in pure entity-attribute-value (EAV) tables (containing only three columns) in which all data is stored in a single ‘value’ column, with a second ‘attribute’ column containing a descriptive label for the data element in the value column, and a third ‘entity’ column containing an item identifier that is used to group together related data from different rows, or in any hybrid combination of the above or in any other convenient structure.

The methods by which data is written into and retrieved from a table 404 are explicitly defined in such a way as not to assume or depend upon anything except the specific data element being read or written, together with any descriptive attributes and metadata that may exist for that specific instance of that particular data element. The benefits of this particular method are highly significant in producing overall benefit in the later management and operation of the system. As previously stated, the contents of any cell of any table 404 is written by the action of a single script upon a single message and message context and those antecedents are instantly available for the contents of any cell.

A baseview constructor 502 acts as a shared stable data resource that provides a layer of indirection between the tables 404 and any person or process seeking access to the information stored in the 404 tables. This layer of indirection serves as a location in which to bind default display properties, row-restrictive criteria, row-to-column conversions, and such other metadata and attributes as may be useful in defining cohorts of records and lists of data elements for each record in a cohort. An arbitrary number of baseview constructors 502 may be defined within the system, and new baseview constructors 502 may be created at any time to meet any need baseview constructors 502 produce baseviews, a form of virtual databases or virtual tables containing only records matching a set of criteria (cohorts) where each record is constructed from data elements that may exist in one or more tables.

Stored attributes and metadata may be applied to each data element as part of this process, or attributes and metadata may themselves be treated as (and thereby become) data elements themselves. Arbitrary transformations may also be applied at this stage. For example, a virtual ‘name’ field may be defined by trimming and assembling data from the last name, first name, and middle name fields. Baseviews thus present a series of data elements that appear to exist in a single flat table, regardless of where and how they may actually be stored—even if they are actually stored as a series of rows in an EAV table or as a complex data structure in a generic column within a hybrid data table.

Besides the original table and field names for each component of an included data element, baseviews also contain a preferred title and description for each exposed data element. Baseviews also contain a series of attributes (e.g., ‘hints’) used in the downstream display and transmission of data as represented by the baseview. Hints may affect any aspect of the behavior of any downstream module or component that may receive or work with data from the baseview. For example, a baseview would contain sorting hints when a date is to be displayed without the time but the sorting order should include the time or when a data element is displayed as a character string but the sorting order should be numeric, or when pseudo-numeric sorts should include an implicit leading zero.

Default font choices, column widths, and other display attributes may also be localized within a baseview, becoming available to user views 602 and to other downstream processes, each of which has the ability to accept the defaults or to apply any other value desired. Each data element defined within a baseview may also have special components associated with it, such that a particular component may be invoked by any downstream process to perform special functions related to that specific data element. In some cases, the effect is as if the data element were an object and the component were a method of the object but in other cases the component has little to do with the data element itself, merely being triggered by actions or events involving the data element.

For example, data elements defined in a baseview may be displayed in a grid such that each column of the grid contains a specific type of data element. Clicking on any cell or on the header row of the grid might then invoke a component that had been defined in the baseview as being associated with that particular data element. The invoked component might then perform any arbitrary function. For example, it might display a real-time view of the activity of the MTAs (e.g., 304, 306) and DTEs (e.g., 402) involved in the arrival of new data destined for that column, or it might open up a metathesaurus browser with the opening location set to the concept unique identifier corresponding to the data item of the column.

One important function of the components is to manage the display of multi-valued data elements related to those displayed in a grid or summary or snapshot of the data. For example, a baseview element representing the date or time at which new lab test results last became available may be linked to a component that displays all lab tests organized by time and by type, or in any other manner. Similarly, a baseview element representing the triage time may be linked to a component for data entry related to the triage process. Importantly, baseview constructors 502 create cohorts by applying a series of filtering criteria used to define what entities will be included in the rows that may be presented as part of the baseview.

Filtering criteria defined by a baseview constructor 502 may include any combination of criteria applied in any way to any data elements within the system, and the criteria may be applied internally or may require calls to an external system or process. Examples of methods of creating and combining filter criteria include Boolean combinations, superposition combinations, fuzzy or partial-set-membership combinations, and combinations developed through iterative, complex, neural network-based, evolved, N-dimensional fractal, or other techniques that may or may not be able to be expressed in a series of human-readable or human-comprehensible rules or actions. For example, a baseview may contain a list of fields to be associated with columns in a display, and may define the contents of those columns over a list of rows that are constrained to include only records containing an IP (Internet Protocol) address that is judged by an external system to have poor connectivity, where the criteria for poor connectivity may be arbitrarily complex, applied by an external program, and thus may be completely unknown to the system.

As another example, a baseview may permit working with specific data elements for all patients who are judged by a fuzzy set process to be ‘tall,’ where the meaning of ‘tall’ is not precisely defined and a given person may be judged ‘tall’ in one context and ‘not-tall’ in another. In more common examples, a baseview might contain all known medical data elements for all patients at a particular hospital or in a particular city or belonging to a certain doctor or a certain insurance plan during a certain range of dates.

A user view 602 contains a subset of data elements chosen from a single baseview, together with a number of user-specified attributes specific to that view. User views 602 are defined at the level of a system user account thus are specific to a user. However, any user can be defined as a ‘user group’ and any user can be assigned as a ‘member’ of one or more user groups. A user view 602 that is defined for a user group can be inherited by all users who are members of that group. One important view attribute is a defined ordinal arrangement of the selected data elements. The ordinal arrangement is used to order data in a report or outbound message, and also to order data within a grid or spreadsheet display or any other module or component that may receive the data for analysis and presentation.

Another example of view attributes would be the column width and title: a default column width and title to be displayed for each data element is inherited from the baseview, but these will be pre-empted by user defined column titles and widths if they exist within a user view 602. Other common user view 602 attributes include setting a column visible or invisible and setting complex filter and sort criteria based on any combination of data elements. Filter and sort criteria are similar to those used with the baseview constructor 502, but within a user view 602 the filter criteria are additive to those defined by the baseview, while any user view sort criteria will replace the defaults inherited from a baseview filtering and sorting criteria may be applied temporarily, in which case they remain in effect only so long as the view remains open, or permanently, in which case they are saved with and become part of the user view and remain in effect until explicitly changed.

Simple filters are those that reference single-valued data elements (e.g., single-valued with respect to the currently active row-defining attribute). For example, a filter that shows only patient records where the medical record number was some defined number (e.g., all records for a specific patient) is a simple filter. Another simple filter would show only those patients whose latest temperature is greater than 101 degrees and whose current location is the intensive care unit. Cohort filters (e.g., complex filters) are those referencing data elements that may be multi-valued or may vary over time. For example, a filter that shows ‘all patients who had at least one temperature greater than 101 degrees occurring while in the intensive care unit during the prior month, and who had a consultation by a pulmonary specialist during the 3 days prior to that episode of fever’ would be a cohort filter.

Cohort filters are applied by referencing a start date-time and a stop date-time for each data element that is referenced in the filter logic and determining whether the combination was true within the period of interest. The ability to easily perform such cohort-based filtering is an important and unusual aspect of the system. A common function performed within a user view 602 is the invocation of a component as defined within the system and as linked to some data element within the baseview constructor 502. Such components may be organized into menus for ordinary navigation, and may be invoked from such a menu or directly from a display of data elements. Components inherit a context including the current baseview and all associated attributes, the current user view 602 and all associated attributes, the current row selection, and the current column selection, and may act in any way desired with that context, or may ignore that context entirely if their purpose is to perform some other function.

Components commonly display multi-value data, such as all the X-ray images for a specific patient visit, or all the lab results for all visits for a patient. Components also commonly display data that is more extensive or formatted in a particular manner or placed in a different display context, such as dictated note transcriptions linked to the associated audio, or N-dimensional graphical displays that are used for advanced data visualization. Components are also responsible for data entry, the results of such data entry being delivered to an SDE 302 and back through the entire process as described above.

Some particular aspects of the system 700 that are of unique value and importance include, but are not limited to the following. The system 700 provides for late binding. Where traditional systems pre-define system functions and behaviors and bind them into the core of the application where they are hard-coded, this system 700 employs and enforces the concept of late binding to such an extent that virtually any function or behavior is or may be defined and instantiated by a power user or system analyst.

Entirely new components may be created by educated end-user and may be bound into the system merely by invoking them, such that they then appear to be fully integrated within the system as if they had been hard-coded as part of the core application. Most desired functionality can be expressed merely by altering the configuration of the system for a single user, however when new components are needed to achieve truly new functionality, it is generally easier and less expensive to add such new functionality as a late change order than it would be to add it at any earlier time.

The subject innovation employs layer separation. Traditional approaches create or permit dependencies between source data systems and data management systems, and similarly create or permit dependencies between and among different modules of a system. In contrast, the subject innovation enforces a strict separation of layers such that there are guaranteed to be no dependencies between the three primary layers of data acquisition, data storage, and data presentation.

Additionally, the innovation discloses proper binding different from traditional approaches that may bind system functions anywhere in the system and still permit them to affect different events along the chain of data acquisition, transformation, storage, recovery, and presentation. This traditional approach leads to implicit cross-layer dependencies, which makes a system much more difficult to maintain, and it also leads to inefficiencies. In contrast, the subject system 700 pays rigorous attention to separation of layers and binds each function at a single layer, prohibiting any action at any other layers except through the medium of data stored in data-centric tables. It is to be understood that proper binding can transform complex reports and analyses, reducing execution time in some cases by more than 95%.

Still further, the innovation promotes avoidance of dependencies. Separation of layers and enforcement of local binding of functions both help to prevent undesirable dependencies within the system. Another important method for avoiding dependencies is the fact that data transformation engine threads each are localized to a single table, with each data element of a table corresponding to exactly one script. Strong encapsulation at the level of hardware, software, and communications also serves to eliminate cross-dependencies, such that within the system 700 it is possible to modify or damage any functional component with certainty that no other component will be directly affected in any way. This architecture makes regression testing unnecessary, with a significant improvement in overall maintainability and in the ability to provide enhanced capabilities on demand.

With regard to data centricity, no process or function in the system is ever attached to, coupled with, or driven by another process or function, except that any process or function may trigger notification events that may be received by any other process or function of the system 700. Processes and functions may gain access to information about the system 700 and to data contained within the system 700 only by reading data tables or representations of data tables. All data exchange and all communication is carried out via this data-centric architecture.

Turning now to data atomicity, as described above, in aspects, no external structure survives the transformation of data as it enters the system 700, nor is any presentation-layer or delivery-layer structure implicit in the internal data storage of the system 700. Rather, each data element is stored atomically, and attributes and metadata are used to encode and store all information that was previously encoded in the structure of a source system or that would potentially be encoded in the structure of an outbound data feed or a presentation-layer display. As data arrives structure is converted to metadata, and as data leaves or is displayed metadata is or may be converted to structure, and the outbound or display structures need not match any inbound structures.

The subject innovation facilitates universality as there are no hierarchically or relationally-defined identifiers or attributes in the system 700. No special identifiers or aggregation keys exist. For example, a person-ID such as a medical record number is treated no differently than any other data element. Rather, the system 700 is so devised as to make it equally easy to aggregate and organize information on the basis of most any attributes that may exist relative to a particular data element or group of elements.

Another important attribute of the system 700 is that of strong encapsulation, in that it may be made to operate perfectly despite the complete absence of knowledge by one component or layer of how another component or layer is crafted or configured, and that changes to one component or layer may be made asynchronously with changes to other components or layers. There is a significant advantage in the ability to remove all dependencies of one component or layer upon another, so that every part operates independently and without any global direction, and still to produce an operating whole that behaves as though all the parts were tightly integrated together and directed by a single procedural process.

A related attribute is the fact that all parts of the system 700 are able to function without a priori or designed-in knowledge of the structure or content of the data that is being managed; where manipulations are to be based upon some portion or attribute of the content of a data element or data stream, the processes responsible for such manipulation are late-bound and are implemented either as a series of parameters or as an embedded script. The system 700 thus is capable of handling most all data types, structures and data streams identically. The foregoing and additional advantages of the innovation together with the structure characteristic thereof, though only briefly summarized in the foregoing passages, will become more apparent to those skilled in the art upon reading this detailed description, taken together with the illustrations thereof presented in the accompanying drawings.

As a practical matter, the system 700 differs from other systems in many concrete ways, each providing important advantages for the system 700. By way of example, the subject system 700 does not require monitoring any specific records, but may receive data of many types. It does not require any specific analysis, but permits most any analytic method to be embedded as a late-binding event, at the time of execution of an automated process or at the time of a user-instantiated interaction. It is not focused on answering specific predetermined questions, but permits the discovery of answers to questions related to the various data elements within the system 700 or to relationships, apparent or unapparent, between various data elements within the system 700 or discoverable by the system 700.

It is not necessary to check at predefined intervals for data related to activities that have occurred during the preceding interval, nor does it define or relate to successive time intervals. It is not bound to a 24-hour period or to any other interval. It does not, a priori, partition events into counts per interval. It is capable of assessing the rate of rise or fall or changing distribution of events using most any equation or combination of equations including scatter plots and continuity equations that do not require counting events per interval or comparing to prior intervals.

Instead of being restricted to batch-mode collection of aggregate or summary data and being restricted to the application of pre-defined thresholds of comparison, the subject innovation provides a method whereby highly granular detail data from all ordinary activity in a field of interest is captured automatically and/or manually, and is aggregated together regardless of where or how generated and regardless of whether or not it seems to be related to or useful for any purpose whatsoever. Data from automatic sensors can be received and managed identically alongside data from human observation or other human activity.

The innovation does not necessarily clump data of particular types together into classes a priori. Thus, for example, the innovation does not expect to receive data partitioned as to the type of medication that had been prescribed, purchased, or administered. Rather, it receives data elements in their most granular form, with as many descriptive metadata elements as may be received or ascertained from the process of receiving the data. Any aggregation of data into cohorts for analysis occurs at the time of analysis, rather than at the time of data acquisition.

The subject innovation is not confined to detecting whether the counts of a certain event have increased compared to prior periods, or which types of events have increased. Instead, it may detect and reveal any number of detailed relationships between and among data elements, the most trivial of which would include a rise or fall over time or space in the absolute or relative or percentile count of events of any type. It is capable of detecting trends over time and over space by applying any number of analytical methods that may exist within or be added to or called by the system, and applying those methods to any cohort of data that exists within the system, defined according to criteria that may be specified at the time of the analysis.

In one aspect, the innovation does not depend upon zip codes for spatial localization, but can receive most any level of geospatial information in any format and can transform that information into an exact spatial coordinate system with a defined zone of error of any size, displaying the location of each event or of any group or cluster of events on a variety of maps, aerial and satellite photographs and globe projections. Data received from a data source need not include detail information related to the identification and description of data elements; instead, details may be derived from index systems, data dictionaries, and externally controlled vocabularies that are related to the acquired data elements by virtue of the data itself or on the basis of any metadata that may describe the acquired data elements.

For example, when pharmaceutical data is received, the minimum information identifying a particular medication is supplemented by large amounts of additional information from a variety of databanks including public sources as well as proprietary information licensed for use within the system. The association between a particular data element and other data elements does not depend on external knowledge, but rather may be developed within the system 700 from observed associations. For example, the association between a medication and the diseases for which it is used does not depend on a predefined association, but may be developed as needed by noting which medications have been given to patients with which diagnoses.

External data sources, such as the list of FDA-approved indications for a drug, may serve as a basis for some associations, but such lists inevitably fail to include off-label uses and recent expansions of use. An important feature of the system 100 is the ability to expand such associations based on real-world data within the system. Inferences about one data element based on observations made upon another do not require previously known associations and do not require that counts of pre-defined pluralities of groups of data elements be sent when a network link is established. The system 700 can define pluralities in a post-hoc fashion based on granular data that has been acquired in a real-time or near-real-time fashion without any prior indication of how the data is to be used or what groupings would be used to group data elements into pluralities.

There is no need to establish and terminate connections or network linkages, since the majority of data transfers are carried out in real-time or near-real-time and may occur within the context of always-available connections. A networking layer can be assumed to be available at all times, and the system 700 will automatically queue any data that needs to be transferred during a period when the network is unavailable for some temporary reason. Sorting of data is not a feature or function related to a specific data transfer, and there are no predefined sorting criteria related to type of data or data content.

For example, there is no specification that the system 700 can or does sort by zip code, by price, or by practitioner ID. Rather, at the time of viewing or of analysis the system intrinsically permits sorting data based on any complex algorithm involving any transformation of any combination of data elements contained within the system 700 or accessible by the system 700 as descriptive metadata for any elements of interest. Where analytic methods are applied to the data, the system 700 does not require an analytic method to be predefined as a series of acts, but rather allows an analytic method to be defined at some later time as a single equation or a series of equations, or as a single program or script or a series of programs or scripts, or as an external process that may be automatic or manual, and analog or digital.

The innovation does not require that data be partitioned into counts per interval, nor that counts be compared to a predetermined standard. Instead, it allows data to be un-partitioned or to be partitioned in many different ways, and (whether or not temporal clumping is used) the data may be compared to itself and to other populations of data within or outside the system 700 using most any traditional statistical methods and any new or modified methods that may appear.

The subject system 700 does not use the concept of a predetermined standard for comparison. Rather, it can compare any attributes of data elements aggregated according to any combination of filtering criteria applied to data elements or metadata existing within the system. Filtering criteria can be applied in Boolean combinations or in combinations using Bayesian methods, partial-set-membership (e.g., fuzzy set/logic) methods, superposition principle methods, weighted rule methods prioritization methods, artificial intelligence methods, machine learning & reasoning mechanisms, or any other methods that may be desired.

The system 700 may be used to detect the occurrence of some anticipated event within a population that may be defined by any criteria. When used for this purpose the system does not require a specific series of data collection acts followed by a specific series of analysis acts. For example, it does not depend upon checking with outside systems to obtain the counts of specific events during predefined intervals of time for comparison to aggregate counts similarly obtained for similar prior periods, nor upon analyzing such counts to determine what other events may be associated with the counted events, nor upon checking additional systems or sources of data for additional information related to the derived events.

Rather, the subject system 700 simply allows all known data from all sources to be displayed together and analyzed together using any analytical method, whether it be discrete, continuous, digital, analog mathematical, logical, or graphical in any number of dimensions. Patterns or anomalies that are perceived may be used to trigger other events or analyses, including notifications by any means and actions of any kind that may be carried out by a job server or any other module integrated into or callable by the system 700. This method need not be episodic or periodic. It does not operate on a daily schedule or any other periodic schedule, but rather operates in near-real-time. Each new data element in a source system can be extracted and transmitted at the earliest moment of existence, or at the earliest time possible for the sending system. Each analytic method may be triggered by the arrival of any data element that is able to affect the outcome of that method, thus if an action is to be triggered, it will occur at the earliest moment when that is possible.

It is to be understood that this approach conveys significant advantages over an approach that depends on a periodic collection of data for later analysis. It is not necessary that data conform to a particular standard or format in order to be received by the system 700. Rather, data messages may be received in most any format: fixed record-format with single or multiple record definitions, delimited records using any binary pattern as a delimiter, tagged records using any binary pattern or fixed or relative location to associate tags with related data elements, and content-identified records in which each element of data serves as its own tag or its own delimiter, based on knowledge about the content of the data stream or on inferences drawn from the real data stream as received.

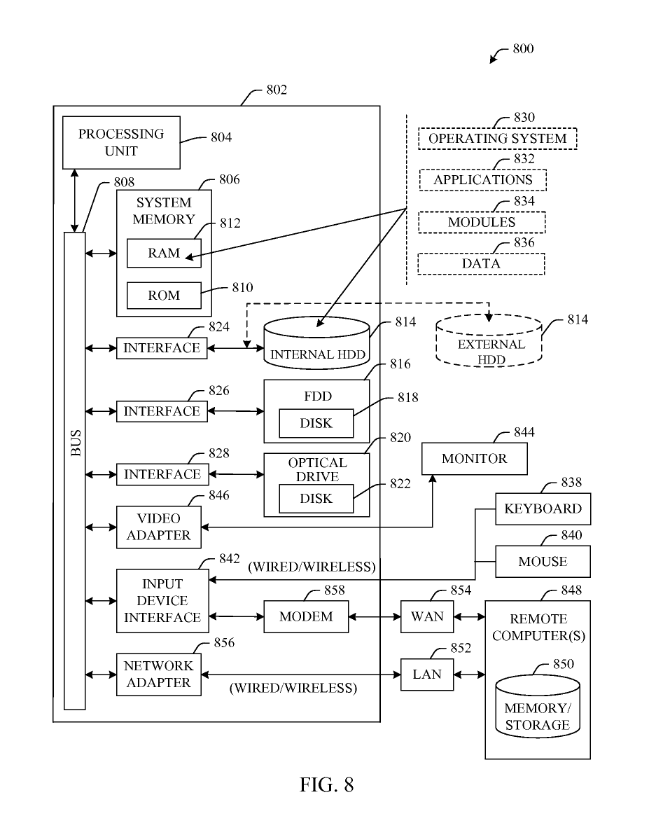

Referring now to FIG. 8, there is illustrated a block diagram of a computer operable to execute the disclosed architecture. In order to provide additional context for various aspects of the subject innovation, FIG. 8 and the following discussion are intended to provide a brief, general description of a suitable computing environment 800 in which the various aspects of the innovation can be implemented. While the innovation has been described above in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 8, the exemplary environment 800 for implementing various aspects of the innovation includes a computer 802, the computer 802 including a processing unit 804, a system memory 806 and a system bus 808. The system bus 808 couples system components including, but not limited to, the system memory 806 to the processing unit 804. The processing unit 804 can be any of various commercially available processors. Dual microprocessors and other multi-processor architectures may also be employed as the processing unit 804.

The system bus 808 can be any of several types of bus structure that may further interconnect to a memory bus (with or without a memory controller), a peripheral bus, and a local bus using any of a variety of commercially available bus architectures. The system memory 806 includes read-only memory (ROM) 810 and random access memory (RAM) 812. A basic input/output system (BIOS) is stored in a non-volatile memory 810 such as ROM, EPROM, EEPROM, which BIOS contains the basic routines that help to transfer information between elements within the computer 802, such as during start-up. The RAM 812 can also include a high-speed RAM such as static RAM for caching data.

The computer 802 further includes an internal hard disk drive (HDD) 814 (e.g., EIDE, SATA), which internal hard disk drive 814 may also be configured for external use in a suitable chassis (not shown), a magnetic floppy disk drive (FDD) 816, (e.g., to read from or write to a removable diskette 818) and an optical disk drive 820, (e.g., reading a CD-ROM disk 822 or, to read from or write to other high capacity optical media such as the DVD). The hard disk drive 814, magnetic disk drive 816 and optical disk drive 820 can be connected to the system bus 808 by a hard disk drive interface 824, a magnetic disk drive interface 826 and an optical drive interface 828, respectively. The interface 824 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 802, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the innovation.

A number of program modules can be stored in the drives and RAM 812, including an operating system 830, one or more application programs 832, other program modules 834 and program data 836. All or portions of the operating system, applications, modules, and/or data can also be cached in the RAM 812. It is appreciated that the innovation can be implemented with various commercially available operating systems or combinations of operating systems.

A user can enter commands and information into the computer 802 through one or more wired/wireless input devices, e.g., a keyboard 838 and a pointing device, such as a mouse 840. Other input devices (not shown) may include a microphone, an IR remote control, a joystick, a game pad, a stylus pen, touch screen, or the like. These and other input devices are often connected to the processing unit 804 through an input device interface 842 that is coupled to the system bus 808, but can be connected by other interfaces, such as a parallel port, an IEEE 1394 serial port, a game port, a USB port, an IR interface, etc.

A monitor 844 or other type of display device is also connected to the system bus 808 via an interface, such as a video adapter 846. In addition to the monitor 844, a computer typically includes other peripheral output devices (not shown), such as speakers, printers, etc.

The computer 802 may operate in a networked environment using logical connections via wired and/or wireless communications to one or more remote computers, such as a remote computer(s) 848. The remote computer(s) 848 can be a workstation, a server computer, a router, a personal computer, portable computer, microprocessor-based entertainment appliance, a peer device or other common network node, and typically includes many or all of the elements described relative to the computer 802, although, for purposes of brevity, only a memory/storage device 850 is illustrated. The logical connections depicted include wired/wireless connectivity to a local area network (LAN) 852 and/or larger networks, e.g., a wide area network (WAN) 854. Such LAN and WAN networking environments are commonplace in offices and companies, and facilitate enterprise-wide computer networks, such as intranets, all of which may connect to a global communications network, e.g., the Internet.

When used in a LAN networking environment, the computer 802 is connected to the local network 852 through a wired and/or wireless communication network interface or adapter 856. The adapter 856 may facilitate wired or wireless communication to the LAN 852, which may also include a wireless access point disposed thereon for communicating with the wireless adapter 856.

When used in a WAN networking environment, the computer 802 can include a modem 858, or is connected to a communications server on the WAN 854, or has other means for establishing communications over the WAN 854, such as by way of the Internet. The modem 858, which can be internal or external and a wired or wireless device, is connected to the system bus 808 via the serial port interface 842. In a networked environment, program modules depicted relative to the computer 802, or portions thereof, can be stored in the remote memory/storage device 850. It will be appreciated that the network connections shown are exemplary and other means of establishing a communications link between the computers can be used.

The computer 802 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

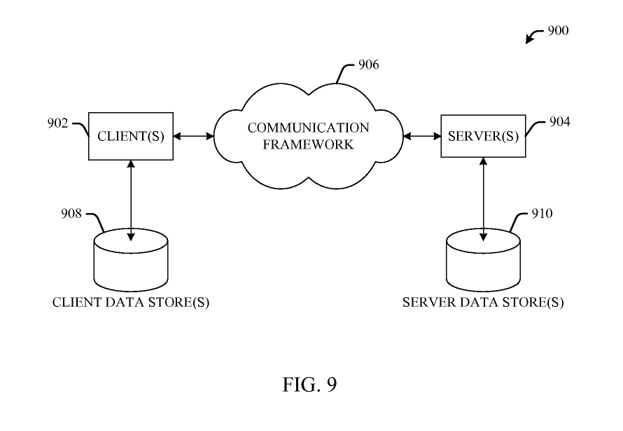

Referring now to FIG. 9, there is illustrated a schematic block diagram of an exemplary computing environment 900 in accordance with the subject innovation. The system 900 includes one or more client(s) 902. The client(s) 902 can be hardware and/or software (e.g., threads, processes, computing devices). The client(s) 902 can house cookie(s) and/or associated contextual information by employing the innovation, for example.

The system 900 also includes one or more server(s) 904. The server(s) 904 can also be hardware and/or software (e.g., threads, processes, computing devices). The servers 904 can house threads to perform transformations by employing the innovation, for example. One possible communication between a client 902 and a server 904 can be in the form of a data packet adapted to be transmitted between two or more computer processes. The data packet may include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

Appendix A describes various aspects of the subject innovation, and this appendix is to be considered part of the detailed specification of this application.

What has been described above includes examples of the innovation. It is, of course, not possible to describe every conceivable combination of components or methodologies for purposes of describing the subject innovation, but one of ordinary skill in the art may recognize that many further combinations and permutations of the innovation are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates data management, comprising:
a data collection layer that monitors a plurality of sources and dynamically determines relationships and retrieves a plurality of health-related data elements from a subset of the sources as a function of the relationships, wherein at least two of the plurality of health-related data elements have disparate formats; and
a data presentation layer that facilitates render of a subset of the health-related data elements.

2. The system of claim 1, wherein the data collection layer automatically identifies one of a pattern or a trend in data elements of the plurality of sources and retrieves the plurality of health-related data elements as a function of the pattern or the trend.

3. The system of claim 2, wherein the pattern or trend is related to a health threat and the data presentation layer facilitates notification to an appropriate party based upon the health-related threat.

4. The system of claim 2, the pattern or the trend is at least one of temporal, geospatial or multi-dimensional.

5. The system of claim 1, further comprising a data transformation layer that transforms the health-related data elements to a core element and a metadata element, wherein the metadata element is employed to discern the relationships.

6. The system of claim 1, a subset of the sources are electronic and a subset of the sources are non-electronic sources.

7. The system of claim 1, further comprising a source data extractor that monitors the plurality of sources in real-time and obtains the plurality of health-related data elements.

8. The system of claim 7, further comprising a source multi-protocol transfer agent that receives and transmits the subset of health-related data elements to a plurality of receivers.

9. The system of claim 8, at least one of the plurality of receivers is a core multi-protocol transfer agent that authenticates the received subset of health-related data elements, tags the subset of health-related data elements with metadata and places the subset of health-related data elements into a storage location for subsequent rendering.

10. The system of claim 9, the storage location is a message queue that maintains health-related data element of disparate formats or structures.

11. The system of claim 10, further comprising a data transformation engine that reads the subset of health-related data elements from the message queue and applies a transformation to generate metadata that is stored in at least one table.

12. The system of claim 11, further comprising a baseview constructor that applies a late binding mechanism to establish a cohort of the subset of health-related data elements.

13. The system of claim 12, further comprising a user view that renders the cohort of the subset of health-related data elements to one of a user and a component.

14. The system of claim 1, further comprising an artificial intelligence (AI) component that employs at least one of a probabilistic and a statistical-based analysis that infers an action that a user desires to be automatically performed.

15. A computer-implemented method of data management, comprising:
monitoring a plurality of sources having a plurality of health-related data elements of different formats;
extracting a subset of the health-related data elements as a function of a pattern;
transforming each of the subset into a core element and a metadata element;
storing the core element and the metadata element;
establishing a cohort of the subset of health-related data elements based upon associations as a function of the metadata elements; and
rendering the cohort of the subset of health-related data elements.

16. The computer-implemented method of claim 15, further comprising authenticating each of the subset of the health-related data elements as a function of an origin of each of the subset of the health-related data elements.

17. The computer-implemented method of claim 15, further comprising tagging each of the subset of the health-related data elements, wherein the tags are employed to establish the cohort.

18. The computer-implemented method of claim 15, wherein the act of rendering includes triggering an action.

19. A computer-executable system that facilitates management of data, comprising:
means for monitoring a plurality of sources in real-time;
means for extracting a plurality of health-related data elements in real-time from a subset of the plurality of sources;
means for authenticating each of the plurality of health-related data elements;
means for buffering each of the authenticated health-related data elements;
means for transforming each of the authenticated health-related data elements into core data elements and metadata elements;
means for inserting the core data elements and the metadata elements into a plurality of tables;
means for selecting a cohort of the core data elements and the metadata elements from a subset of the tables; and
means for rendering the cohort.

20. The computer-executable system of claim 19, further comprising means for triggering an action as a function of the cohort.
